(19) United States
(12) Patent Application Publication
(10) Pub. No.: US 2007/0176314 A1
(43) Pub. Date: Aug. 2, 2007

(54) Apparatus for manufacturing display device and method of manufacturing the same

(75) Inventors: Yang-Ho Jung, Yongin-si (KR); Kyu-Young Kim, Suwon-si (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd., Suwon-si (KR)

(21) Appl. No.: 11/542,331

(22) Filed: Oct. 2, 2006

(30) Foreign Application Priority Data
Feb. 2, 2006 (KR) 10-2006-0009978

(51) Int. Cl. B29C 35/08; B29C 59/02

(52) U.S. Cl. 264/83; 264/320; 264/494; 425/374

(57) ABSTRACT

A method of manufacturing a display device according to an exemplary embodiment of the present invention includes applying an organic material onto a substrate that is mounted on a supporting plate, contacting a surface of the mold on which a predetermined pattern is formed with the organic material, disposing the supporting plate an at angle, and pressing the mold while rotating the pressure roller. Therefore, the apparatus and method for manufacturing a display device according to the embodiment of the present invention have advantages that bubbles generated from the organic material are removed by using an inclined supporting plate and rotating the pressure roller in a direction opposite to the moving direction, thereby suppressing the formation of the bubbles.

### CROSS-REFERENCE TO RELATED APPLICATION

This application claims priority to and the benefit of Korean Patent Application No. 10-2006-0009978 filed in the Korean Intellectual Property Office on Feb. 2, 2006, the entire contents of which are incorporated herein by reference.

### BACKGROUND OF THE INVENTION

(a) Field of the Invention

The present invention relates to an apparatus for manufacturing a display device and to a method of manufacturing the same.

(b) Description of the Related Art

A liquid crystal display is now most widely used among types of flat panel displays. A liquid crystal display includes two display panels with field generating electrodes and a liquid crystal layer interposed between the display panels. By applying a voltage to the electrodes, liquid crystal molecules in the liquid crystal layer are rearranged to control transmittance of light that passes through the liquid crystal layer.

Generally, a photolithography method has been used in order to form various types of thin film patterns for the liquid crystal display devices.

However, the photolithography method has complex processes and expensive cost, which causes poor productivity.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide an apparatus for manufacturing a display device and to a method of manufacturing the same.

An advantage of the present invention is that it provides an apparatus that is capable of manufacturing a display device with simple processes at low cost and a method of manufacturing the same.

An apparatus for manufacturing a display device according to an exemplary embodiment of the present invention may include a supporting plate on which a substrate is mounted, a mold that has a predetermined pattern formed thereon, and a pressure roller that presses the mold, which is in contact with an organic material applied on the substrate. In this case, the pressure roller may rotate in a direction opposite to a moving direction of the pressure roller

Further, the supporting plate may be disposed at an angle.

The apparatus may further include an injection device that injects organic materials in a gas state onto a surface of the mold.

The apparatus may further include a heating device that heats the mold, which is in contact with an organic material on the substrate.

With the above construction, the heating device may be a convection type heating device.

A method of manufacturing a display device according to an exemplary embodiment of the present invention may include applying an organic material onto a substrate that is mounted on a supporting plate, contacting a surface of the mold on which a predetermined pattern is formed with the organic material, disposing the supporting plate at an angle, and pressing the mold while rotating the pressure roller.

In this method, the pressure roller may rotate in a direction opposite to a moving direction of the pressure roller.

The method may further include, before contacting the mold with the organic material, injecting an organic material in a gas state onto a surface of the mold, which is in contact with the organic material.

The method may further include, after contacting the mold with the substrate, heating the substrate, the mold, and the organic material using a heating device.

With this configuration, on the pressured organic material, the same pattern as the predetermined pattern formed on the mold may be formed.

The supporting plate may be inclined such that a side opposite to an initial position of the pressure roller is raised.

The method may further include photo-curing the patterned organic material.

### BRIEF DESCRIPTION OF THE DRAWINGS

FIG. 1 is a perspective view schematically showing an apparatus for manufacturing a display device according to an exemplary embodiment of the present invention.

FIG. 2 is a view showing a state when an organic material is injected using an injecting device according to an exemplary embodiment of the present invention.

FIG. 3 is a view showing a state when the mold is in contact with the organic material and the organic material is heated by using a heating device according to an exemplary embodiment of the present invention.

FIG. 4 is a view showing a state when small bubbles between the mold and the organic material are gathered by heating to form a larger bubble.

FIG. 5 is a view showing a state when the mold is pressed by the pressure roller.

### DETAILED DESCRIPTION OF THE EMBODIMENTS

The present invention will now be described more fully hereinafter with reference to the accompanying drawings, in which preferred embodiments of the invention are shown. As those skilled in the art would realize, the described embodiments may be modified in various different ways, all without departing from the spirit or scope of the present invention.

In the drawings, the thickness of layers, films, panels, regions, etc., are exaggerated for clarity. Like reference numerals designate like elements throughout the specification. It will be understood that when an element, such as a layer, film, region or substrate, is referred to as being “on” another element, it can be directly on the other element or intervening elements may also be present. In contrast, when an element is referred to as being “directly on” another element, there are no intervening elements present.

An apparatus for manufacturing a display device and a method of manufacturing the same according to an exemplary embodiment of the present invention now will be described in detail with reference to the accompanying drawings.

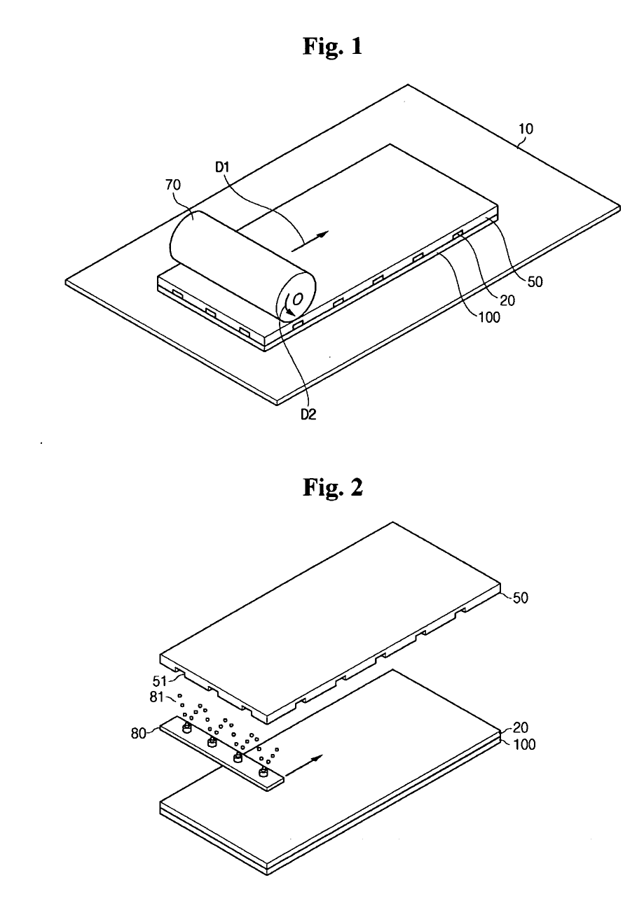

At first, referring to FIG. 1, an apparatus for manufacturing a display device according to an exemplary embodiment of the present invention will be described.

FIG. 1 is a perspective view schematically showing the apparatus for manufacturing the liquid crystal display according to an exemplary embodiment of the present invention.

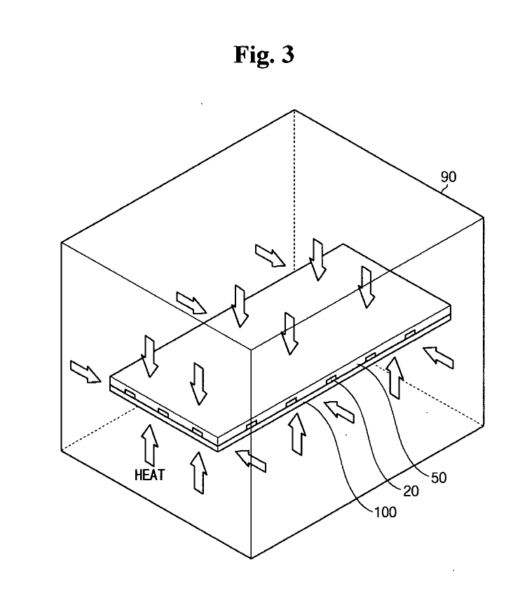

As shown in FIG. 1, the apparatus for manufacturing a liquid crystal display includes a supporting plate 10 on which a substrate 100 is mounted, a mold 50 having a predetermined pattern 51 (shown in FIG. 2) formed on a surface thereof, and a pressure roller 70 that is provided on the mold 50.

The supporting plate 10 may be disposed to be parallel to the ground or disposed at an angle θ with respect to the ground. An anti-sliding member (not shown) is preferably provided on the supporting plate 10 in order to prevent the substrate 100 sliding.

The surface with the predetermined pattern 51 of the mold 50 presses an organic material 20 applied on the substrate 100 to cause the organic material 20 to have the same pattern as the predetermined pattern 51 of the mold 50.

The pressure roller 70 has an elongated cylindrical shape and presses the mold 50. The pressure roller 70 moves in a predetermined direction D1 to uniformly press the entire region of the mold 50. In this case, the pressure roller 70 preferably rotates in a direction D2 opposite to the moving direction D1.

The method of manufacturing the liquid crystal display that is formed as described above will be described in detail with reference to FIG. 2 to FIG. 5 and FIG. 1.

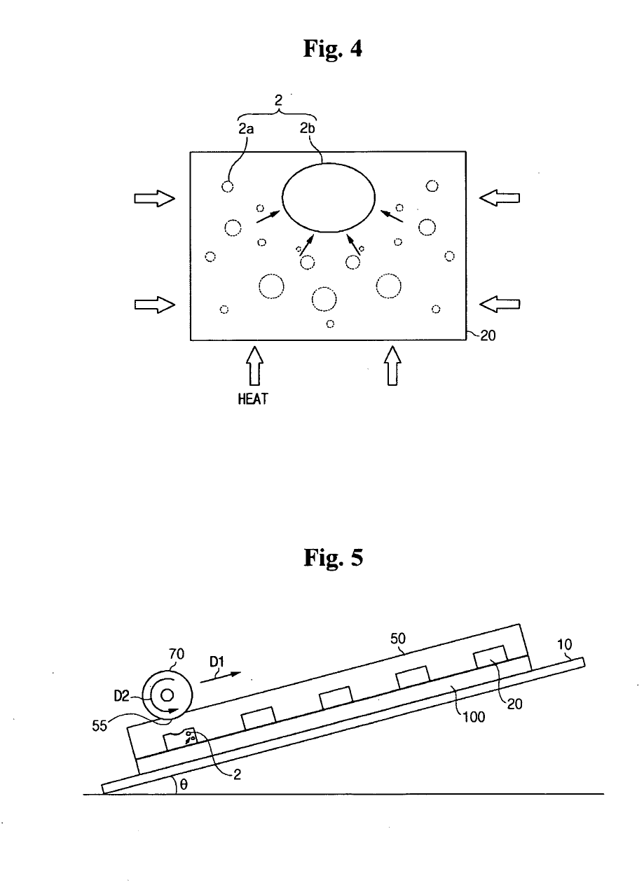

FIG. 2 is a view showing a state when an organic material is injected using an injecting device according to an exemplary embodiment of the present invention, FIG. 3 is a view showing a state when the mold is in contact with the organic material and the organic material is heated by using a heating device according to an exemplary embodiment of the present invention, FIG. 4 is a view showing a state when small bubbles between the mold and the organic material are gathered by heating to form a larger bubble, and FIG. 5 is a view showing a state when the mold is pressed by the pressure roller.

At first, as shown in FIG. 1, a substrate 100 is mounted on the supporting plate 10. And then, as shown in FIG. 2, an organic material 20 with constant viscosity is applied on the substrate 100.

Next, before contacting a mold 50 with the substrate 100 on which the organic material 20 is applied, organic materials 81 that are in a gas state are injected onto the surface of the mold 50 that is to be in contact with the organic material 20 by using an injecting device 80. Thereby, the organic materials 81 are thinly applied on the mold 50.

Next, as shown in FIG. 3, the mold 50 is disposed such that a surface with a predetermined pattern 51 formed thereon faces the substrate 100 to be in contact with the organic material 20 applied on the substrate 100. In this case, the organic material 20 is dispersed in the predetermined minute pattern 51 by capillary action. Therefore, since the contact performance between the mold 50 and the organic material 20 is improved by the organic materials 81 injected onto the mold 50, the formation of bubbles 2 is suppressed. That is to say, the bubbles 2 are easily formed in a space where the mold 50 is not in tight contact with the organic material 20. Therefore, according to the improvement of contact performance between the mold 50 and the organic material 20, it is possible to suppress the formation of the bubbles 2.

Next, as shown in FIG. 3, after the mold 50 is in contact with the substrate 100, the substrate 100, the mold 50, and the organic material 20 are heated using a convection type heating device 90. As shown in FIG. 4, a plurality of small bubbles 2a between the mold 50 and the organic material 20 are combined to form a larger bubble 2b, thereby reducing the number of bubbles 2. Further, heat improves the flowability of the organic material 20 such that the flowability of the bubbles 2 is improved so as to make the formed bubbles 2 be movable.

Next, as shown in FIG. 5, an end of the support plate 10 is raised to make the support plate 10 be disposed at an angle. The angle may be adjustable, and is preferably 3 to 30°. In this case, a side of the supporting plate 10 that is opposite to an initial position of the pressure roller 70 is raised so that the supporting plate 10 is disposed at an angle.

And then, the mold 50 is pressed by the pressure roller 70 while rotating the pressure roller 70 so that the organic material 20 is formed to have the same pattern as the pattern 51 formed on the mold 50.

In this case, when the inclined supporting plate 10 is pressed by the pressure roller 70, the flowable bubbles 2 are gathered at a rolling point 55 due to gravity such that the pressure roller 70 can easily press the bubbles 2 between the mold 50 and the organic material 20.

The pressure roller 70 presses the mold while rotating in a counterclockwise direction D2, which is opposite to the moving direction D1 of the pressure roller 70. In this case, the bubbles 2 can be desirably pressed in the moving direction of the pressure roller 70. Therefore, when the moving of the pressure roller 70 is completed, all of the bubbles 2 are pushed out through an end of the mold 50.

Next, by preceding a photo-curing process, the patterned organic material 20 is cured, and then the mold 50 is removed from the substrate 100.

The above thin film pattern forming method is called an imprint lithography and is preformed by using an apparatus cheaper than photolithography at a reduced processing time with simple processes.

The apparatus and method for manufacturing a display device according to the embodiment of the present invention have advantages that bubbles generated from the organic material are removed by using an inclined supporting plate and rotating the pressure roller in a direction opposite to the moving direction, thereby suppressing the formation of the bubbles.

Further, it is possible to solve the problem that the pattern is damaged by the bubbles that disturb the formation of the pattern during the photo-curing.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An apparatus for manufacturing a display device comprising:
a supporting plate on which a substrate is mounted;
a mold that has a predetermined pattern formed thereon; and
a pressure roller that presses the mold, which is in contact with an organic material applied on the substrate,
wherein the pressure roller rotates in a direction opposite to a moving direction of the pressure roller.

2. The apparatus for manufacturing a display device of claim 1, wherein the supporting plate is disposed at an angle.

3. The apparatus for manufacturing a display device of claim 2, further comprising an injection device that injects organic materials in a gas state onto a surface of the mold.

4. The apparatus for manufacturing a display device of claim 2, further comprising a heating device that heats the mold, which is in contact with an organic material on the substrate.

5. The apparatus for manufacturing a display device of claim 2, wherein the heating device is a convection type heating device.

6. A method of manufacturing a display device, comprising:
applying an organic material onto a substrate that is mounted on a supporting plate;
contacting a surface of the mold on which a predetermined pattern is formed with the organic material;
disposing the supporting plate at an angle; and
pressing the mold while rotating the pressure roller.

7. The method of manufacturing a display device of claim 6, wherein the pressure roller rotates in a direction opposite to a moving direction of the pressure roller.

8. The method of manufacturing a display device of claim 6, further comprising, before contacting the mold with the organic material, injecting an organic material in a gas state onto a surface of the mold, which is in contact with the organic material.

9. The method of manufacturing a display device of claim 6, further comprising, after contacting the mold with the substrate, heating the substrate, the mold, and the organic material using a heating device.

10. The method of manufacturing a display device of claim 6, wherein the same pattern as the predetermined pattern formed on the mold is formed on the pressured organic material.

11. The method of manufacturing a display device of claim 6, wherein the supporting plate is inclined such that a side opposite to an initial position of the pressure roller is raised.

12. The method of manufacturing a display device of claim 6, further comprising photo-curing the patterned organic material.
